(19) United States
(12) Patent Application Publication
(10) Pub. No.: US 2011/0079690 A1
(43) Pub. Date: Apr. 7, 2011

(54) Bucket Engageable Holster for Plastering Tool

(76) Inventor: Raynaldo Segura, Oceanside, CA (US)

(21) Appl. No.: 12/897,695

(22) Filed: Oct. 4, 2010

Related U.S. Application Data
(60) Provisional application No. 61/248,303, filed on Oct. 2, 2009.

(51) Int. Cl. F16M 13/02; A45F 5/00

(52) U.S. Cl. 248/213.2; 224/195

(57) ABSTRACT

A holster for a plaster's hawk. The holster is adapted on a first end to mount upon the lip of a plaster bucket or the belt of a user. Two parallel portions define a space therebetween to frictionally engage the board portion of a hawk. A centrally located gap in said second portion engages with a handle projecting from the board portion and is spaced from the first portion sufficiently to accommodate any padding at the intersection of the handle and the board portion of the hawk.

This application claims priority to U.S. Provisional Patent Application No. 61/248,303.

### BACKGROUND OF THE INVENTION

1. Field of the Invention

The invention herein disclosed relates generally to on the job storage of a plastering tool. More particularly it relates to a holster device adapted to engage a conventional bucket or pail or a belt used by plasterers on job sites which will provide a secure but temporary engagement for a plaster hawk during periods of non use.

2. Prior Art

Plaster work is one of the most ancient of building techniques employed by man. Modern archeologists have found that ancient structures such as the pyramids in Egypt contain plaster work executed at least four thousand years ago. The techniques and materials employed for plastering and the like have varied little through modern times.

The professional plasterer employs a few primary tools along with their professional skills to apply plaster on a job site.

Conventionally, the plasterer employs a 5-gallon bucket which may be partially filled with water. Another main tool is the trowel for laying plaster or mud on the wall depending on the point in the construction on which the plasterer is working. A third item employed widely is a hawk. The hawk consists of a board about 9 inches square, having a working surface on one side and a perpendicular handle fixed centrally on the reverse. A pad is generally positioned upon the base of the handle adjacent to its engagement to the board to pad the user's hand from the weight of the hawk and any material which is placed on the board.

In use by a plasterer, the hawk is employed to hold the mixed working plaster being used by the plaster on the job site. It is held horizontally in the craftsman's non-dominant hand with the smooth side of the board, opposite the handle, being upright. This leaves the plasterer's dominant hand to employ a float (a flat board with a handle) to apply the wet plaster to the wall and produce a smooth finish.

The hawk is also employed by brick pointers to hold mortar while they work. Hawks are becoming increasingly popular among drywall finishers to hold their joint compound on the board while they employ their working hand to apply the compound.

However, a problem exists for professional plasterers when they are not employing their hawk for work purposes, but must transport it or have it with them in case it's needed. The board portion of the hawk is planar and large making it unwieldy and ill suited for engagement to a tool belt as a smaller trowel or other tool might be carried.

On high rise building job sites, this lack of a secure and convenient means to holster and carry the bulky plastering hawk is fraught with peril. Plasterers on upper floors, carrying a heavy bucket and other requirements for the job, may not have the best of grips on their large plastering hawk. Should it slip from their grasp or a jerry-rigged engagement to the bucket, severe injuries can occur to people on the ground being struck by the large falling hawk.

As such, there exists an unmet need for a device which will allow a plasterer to conveniently carry their large planar plastering hawk along with other tools and the 5-gallon bucket which is always carried with them, or easily engage the same device to their belt. The same device should allow for either a secure removable engagement of the large planar hawk to the large 5-gallon bucket or alternatively to their belt, to thereby allow the plasterer to carry the hawk using the secure grip provided by the bucket handle or a cinched belt. However, while allowing for a secure holster of the hawk, such a device must be lightweight to avoid adding to the heavy weight already carried by the plasterer on any given day. Finally such a device, while securely mounting the hawk to prevent it from falling from a building, needs to also allow for an easy and quick disengagement when the plasterer needs to employ the hawk.

### SUMMARY OF THE INVENTION

The disclosed system herein provides a means to overcome the above noted shortcomings of plaster hawk transport and holstering to date. The device features a body which is lightweight and may be formed of metal or of plastic sheet or tube, with metal being slightly preferred due to its inherent resistance to breaking. In addition to being lightweight, the disclosed hawk holster device is especially well adapted to provide a very secure mount, but very quick and easy disengagement from the mount when the hawk is needed.

The hawk holster device, in one mode, employs a metal or plastic member which is configured in a serpentine fashion to form the device. A first portion of the serpentine member is configured to form a first pair of member portions which have a general U-shape at a mounting end of the device. The parallel U-shaped member portions have a gap between a shorter leg and a longer leg of the U-shaped members. This gap is sized to frictionally engage upon the wall of a conventionally employed 5-gallon bucket which in the as-used position for the device, engages the gap between the short leg and longer leg of the U-shaped members positioning the short legs within the bucket and the U-shape overhanging the lip of the bucket.

Alternatively, the device may be formed of planar plastic sheets which, when molded or fused, form the same angled configuration allowing for the engagement of the hawk.

In the as-used position, the longer leg of each U-shaped member extends downward an extension distance from the lip of the bucket where the longer legs reverse direction in a U-turn back toward the lip of the bucket and from a middle leg on each of the parallel member portions. This extension distance to the second U-shaped transition of the longer leg, between the lip of the bucket and the U-turn upward is a distance sufficient to accommodate the length of the board on the hawk to be engaged in the first slot formed between the longer leg and the middle leg of the device.

The middle leg extends upward a distance slightly less than the downward distance of the longer leg and becomes a connecting leg, traverse to the direction of the member portions formed by the shorter leg, the longer leg, and the middle leg. The connecting leg extends the distance between the two leg portions and holds them in a fixed parallel engagement with each other. The connecting leg, in a mid portion, is configured with a U-shaped second slot, perpendicular to the first slot formed by the longer and middle leg portions. This second slot is formed by bends in the connecting leg. The second slot has a width adapted to frictionally engage along the sides of a handle of a hawk having its board portion engaged within.

Particularly important is the angled direction of end portions of the connecting leg from their engagement to the distal end of the middle leg, and extending to the upper corners of the formed second slot. Both end portions angle away from the sidewall of the bucket from the starting points at the distal end of the middle member, toward the mid portion of the connecting leg where the second slot is formed.

The angled extension of both end portions of the connecting leg provide a means to form a cavity between an inner edge of the second slot, and the sidewall of the bucket, which will accommodate the padding normally positioned on a plasterer's hawk, where the handle meets the board portion. Without these angled sections, the device would not accommodate this widely used, but optional pad, engaged on the hawk.

With respect to the above description, before explaining at least one preferred embodiment of the holster device for a plasterer's hawk, it is to be understood that the invention is not limited in its application to the details of operation nor the arrangement of the components or steps in the method set forth in the following description or illustrations in the drawings. The various methods of implementation and operation of the holster for a plasterer's hawk herein, are capable of other embodiments and of being practiced and carried out in various ways which will be obvious to those skilled in the art once they review this disclosure.

Also, it is to be understood that the phraseology and terminology employed herein are for the purpose of description and should not be regarded as limiting.

Therefore, those skilled in the art will appreciate that the conception upon which this disclosure is based may readily be utilized as a basis for designing of methods and systems for carrying out the several purposes of the present invention which provides a heretofore unavailable secure but removable enragement of a plasterer's hawk to a conventional 5-gallon bucket. Therefore, that the objects and claims herein should be regarded as including such equivalent construction, steps, and methodology insofar as they do not depart from the spirit and scope of the present invention. Further objectives of this invention will be brought out in the following part of the specification wherein detailed description is for the purpose of fully disclosing the invention without placing limitations thereon.

It is an object of this invention to provide a portable storage mount for large and bulky plasterer's hawks which will prevent dropping of the hawk accidentally during use and transport.

It is another object of this invention to provide such a hawk holster which may be easily engaged at a first side to a sidewall of a conventional bucket and at another side to engage the board portion and the handle of a plasterer's hawk.

Yet another object of the device herein is forming such a hawk holster in a configuration which will accommodate the handle pad widely employed on such hawks.

It is another object of this invention, to provide such a hawk holster device, which will securely engage the hawk to a plasterer's bucket and prevent it from dropping from high rise building where it could maim or otherwise harm persons below.

These together with other objects and advantages which become subsequently apparent reside in the details of the construction and operation of the hawk holster system herein as more fully hereinafter described and claimed, reference being had to the accompanying drawings forming a part thereof, wherein like numerals refer to like parts throughout.

### BRIEF DESCRIPTION OF DRAWING FIGURE

FIG. 1 depicts a perspective view of the device, in an as-used position, engaged over the lip of a conventional 5-gallon bucket and forming a frictional engagement with the sidewall of the bucket while concurrently holding a plasterer's hawk securely.

FIG. 2 depicts the device dismounted from its as-used position on the bucket showing the serpentine bending of the member to form two parallel member portions connected by a cross member.

FIG. 3 depicts a top view of the device of FIGS. 1 and 2 showing the angled extension of end portions of the connecting member providing a cavity adapted to allow insertion of a handle with a padded base.

FIG. 4 depicts the device in a similar mode to FIGS. 1-3.

### DETAILED DESCRIPTION OF THE PREFERRED EMBODIMENTS OF THE INVENTION

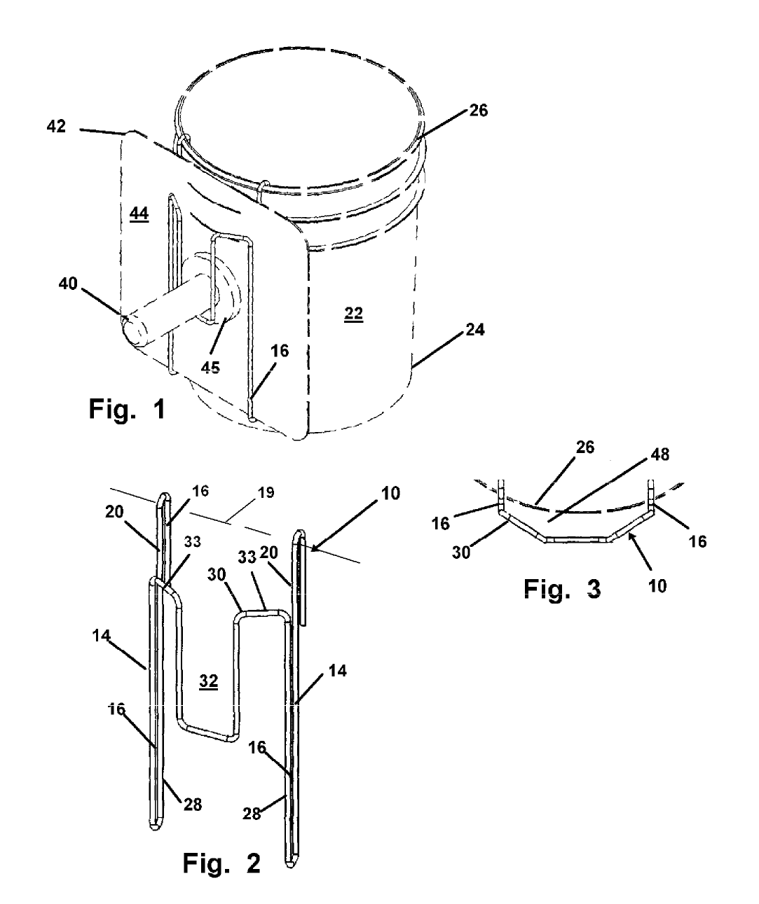

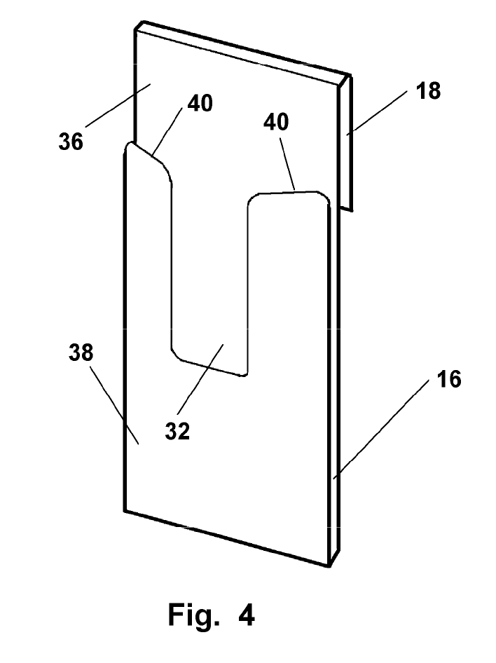

Referring now to the FIGS. 1-4, the hawk holster device 10 herein provides for an as-used engagement to a 5-gallon bucket shown in broken line in FIG. 1. The device 10 as shown in FIGS. 1-3, is formed by a metal or plastic serpentine shaped member which is configured with curved portions and parallel portions to form the device 10. The device 10 as shown in FIG. 4 is formed in planar plastic material which can be injection molded and would have the same angled characteristics of the device 10 formed by the bent members.

A first portion of the device 10 is configured to form a first pair of members 14 having a U-shape at their respective distal ends which has an opening 18 therebetween. The vertically disposed parallel members 14 have inline gaps 16 between a shorter leg 14 portion and parallel longer leg 20 portion of the members 14. The formed inline openings 18 are sized to frictionally engage upon the lip 26 of a belt (not shown but well known), or at the top of a wall 22 of a conventionally employed 5-gallon bucket 24, which is shown in the as-used position in FIG. 1 overhanging the lip 26 of the bucket 24. When overhanging a conventional belt the device 10 would function and appear similarly.

In the as-used position on the bucket or belt, the longer leg 20 of each of the two parallel members 14 extends downward a distance from the lip U-shaped distal end having the openings 18 to fit on the lip 26 or belt, until both longer legs 20 reverse direction in a U-turn back toward the lip 26 engaging end. The reversed portion defines middle legs 28 which extend to a horizontally disposed connecting leg 30. The connecting leg 30 extends a horizontal distance between the two middle legs 28 and at opposing angles which serves to distance a slot 32 from the wall 22 of a bucket or the leg of the user.

At a mid section of the angled connecting leg 30 the U-shaped slot 32, having an imaginary plane running parallel to the gaps 16 formed by the longer leg 20 and the middle leg 28 portions and an imaginary line 19 running through the two belt or lip engaging openings 18. This second slot 32 formed by bends in the connecting leg 30 has a width adapted to engage along the sides of a handle 40 of a hawk 42 when so positioned there in a frictional engagement of the board portion 44 in the two gaps 16 concurrently.

Particularly preferred is the depicted angled direction of end portions 33 of the connecting leg 30 from their engagement to the distal end of the middle leg 28. Both end portions 33 angle away from the imaginary line 19 at equal but opposite angles, and when in the as-used position, form the sidewall of the bucket 24 or leg of the user. The end portions extend from the starting points at the distal end of the middle leg 28, toward the mid portion of the connecting leg 30 where the second slot 32 is formed.

The angled extension of both end portions 33 of the connecting member 30 provide a means to form a cavity 48 between the connecting member 30 and the side wall 22 of the bucket 24, or a user's leg if belt-worn, which will accommodate the padding 45 normally positioned on a plasterer's hawk 42 where the handle 40 meets the board 44. Without these angled end portions 33, the device 10 would not accommodate this widely used, but optional padding 45 on the hawk 42 when the device is engaged in the as-used position of FIG. 1. Thus this configuration accommodates both a hawk 42 without the padding 45, and with the padding 45.

In use, the device 10 engaged with the hawk 42 allows a user to secure the hawk 42 during non use and carry it securely engaged to the bucket 24 or to themselves when engaged to a belt. Removal of the tool is quick and simple by simply sliding the handle 40 from the second slot 32 which slides the board 44 from the gaps 16 where it is frictionally engaged between the middle leg 28 and the longer leg 20 of the member portion 14.

In FIG. 4 there is shown another mode of the device 10 which is formed using injection molded or otherwise configured planar plastic or metal material. It functions in a similar fashion to the device 10 of FIGS. 1-3 with the opening 18 adapted to fit on the lip 26 of a bucket or on a belt. A first planar member 36 extends downward where it reverses and forms an engagement member 38.

The distal edge 40 of the engagement member 38 has a slot 32 formed therein. The two portions of the engagement member 38 on either side of the slot 32 and terminating at the distal edge 40, are formed to angle at equal but opposite angles from the planar surface of the first planar member 36, to position the plane of the slot 32 a distance from the first planar member 36 such that the device functions the same as the first mode and accommodates a hawk 42 with or without padding 45, and holds the board 44 within the gaps 16. This mode of the device 10 may be injection molded from plastic or formed by bending metal to form the shape and may be easier to manufacture while still functioning the same and providing the same utility.

While all of the fundamental characteristics and features of the holster mount for a plaster hawk to a bucket have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the disclosed hawk holster invention as defined by the following claims.

What is claimed is:

1. A holster for removably securing a plaster's hawk for carrying on a belt or a bucket sidewall, comprising:
a first portion of said holster having a first and second end;
said first end terminating in substantially a U-shape thereby defining an opening configured for engagement upon the lip of a bucket or upon a belt of a user;
a second portion engaging said second end of said first portion;
said second portion extending toward said first end of said first portion;
said second portion terminating at a distal end opposite its engagement to said first portion;
a space between said first portion and said second portion, said space dimensioned to frictionally engage the board portion of a plasterer's hawk in contact with a surface of said first portion and said second portion;
a gap formed at the distal end of said second portion and extending into a central section of said second portion situated between to side sections;
each said side sections extending at opposing angles angling from a closest point to said first portion at said space between said first portion and said second portion, to a furthest point from said first portion at an intersection with said gap;
said gap dimensioned for a slidable engagement of a handle extending from an engagement to said board portion while said board portion is within said space;
said side sections extending at said opposing angles providing a means to form a cavity between said first portion and said central section of said second portion, said cavity dimensioned to accommodate a pad positioned at said engagement of said handle; and
whereby said holster may be engaged to said bucket or said belt, and concurrently said board and of said hawk may be slidably engaged or disengaged within said space with said handle extending through said gap, and any pad on said handle positioned within said cavity.

2. The holster of claim 1, additionally comprising:
said first portion formed of elongated members defining sides of said first portion having a void therebetween;
said section portion formed of elongated members defining two parallel vertically disposed side edges connected by a horizontally disposed elongated member defining said distal end of said second portion and said gap therein.

3. The holster of claim 1, additionally comprising:
said first portion formed of elongated planar metal or plastic material; and
said second portion formed of elongated planar metal or plastic material.
